(19) United States
(12) Patent Application Publication
(10) Pub. No.: US 2012/0122349 A1
(43) Pub. Date: May 17, 2012

(54) Electrical Connector And Method For Manufacturing Electrical Connector Assembly

(76) Inventor: Yoshihiko Shindo, Aichi (JP)

(21) Appl. No.: 13/332,567

(22) Filed: Dec. 21, 2011

(30) Foreign Application Priority Data
Jun. 29, 2009 (JP) 2009-154304

(51) Int. Cl. H01R 24/66

(52) U.S. Cl. 439/660

(57) ABSTRACT

To provide an electrical connector in which the length at which contacts held protrude from the connector can be maintained even if the connector is deformed during processing. The electrical connector includes a plurality of contacts and a female housing. The female housing includes a mating connector receiving cavity, a receiving wall disposed along a bottom of the receiving cavity, a plurality of contact receiving passageways holding the plurality of contacts penetrating there through, and a protrusion protruding from the receiving wall into the receiving cavity.

### CROSS-REFERENCE TO RELATED APPLICATIONS

This application is a continuation of PCT International Application No. PCT/JP2010/003800 filed Jun. 8, 2010, which claims priority under 35 U.S.C. §119 to Japanese Patent Application No. 2009-154304, filed Jun. 29, 2009.

### FIELD OF THE INVENTION

The invention relates to an electrical connector and in particular to an electrical connector that maintains contact height even if deformation occurs during manufacturing of the connector housing.

### BACKGROUND

As well-known, an electrical connector generally includes a contact to be electrically connected to a mating connector and a connector housing for holding the contact. Typically, the contact is made of copper or a copper alloy and is highly conductive and elastic. The housing is generally fabricated by injection molding of a synthetic resin. The housing has an opening for receiving and holding the contact. The contact is press-fit into the opening and thereby secured by the housing.

The contact is inserted into the opening of the housing by an automated mechanical device. In the process of inserting the contact into the opening, the contact has to be precisely positioned with respect to the housing. This is because, when the contact is held vertically to a predetermined surface of the housing, the distance from the predetermined surface to the tip end of the contact should lie along a common plane such that the protruding length of the contacts protruding from the reference surface is a preset value, and depends of the electronic connector specifications. Thereby, it is necessary to ensure the required length of each contact from the reference surface be along the common plane such that electrical connection between the contact and the contact of the mating connector is ensured.

To achieve precise press-fitting of the contact into the holding opening, the contact is inserted into the holding opening for a length determined by the length of the contact with respect to the reference surface (i.e. a mating surface).

For example, in the case of a known connector 200 shown in FIG. 6A, the reference surface is a bottom surface 202 of a cavity C of a housing 201 for receiving a mating connector, and contacts 203 are inserted in such a manner that a protruding length L of each contact 203 on the mating side agrees with a preset value.

However, the housing 201 fabricated by injection molding may have a deformation in the bottom surface 202 of the cavity C. The deformation varies with position in the bottom surface 202. Therefore, if the length of insertion of each contact 203 is adjusted with respect to the distorted bottom surface 202, some of the contacts 203 may insufficiently protrude from the design bottom surface 202 indicated by the alternate long and short dash line even if the protruding length L of each contact 203 can be accurately controlled as shown in FIG. 6B. Those contacts 203 retracted from their respective designed positions cannot provide the required length of connection to their respective mating contacts.

Such a significantly deformed housing 201 cannot be put in production, so that the molding surface of the injection molding die is adjusted to reduce or eliminate the deformation. However, whether the deformation is successfully eliminated or not can be assessed only after the adjusted die is actually used for injection molding. Thus, a die for a larger connector, whose reference surface can be more significantly distorted, may need several adjustments. Besides, in the case where the housing 201 has a plurality of cavities C, eliminating the deformation of one cavity is not sufficient, and the reference surfaces of the cavities C have to be aligned with each other on a plane in order to properly position the contacts 203 of the entire connector 200. However, to align the reference surfaces of the cavities C requires many process steps.

In order to address this type of deformation of the housing resulting from injection molding of a resin, Japanese Patent Laid-Open No. 2001-257034 1 proposes a connector positioning structure that positions a connector with respect to positioning protrusions, which are formed at least on a deformed wall portion of the housing and have a protrusion height determined to compensate for a deformation of the protrusions. The proposed structure is designed for precisely mounting a connector onto a connection testing tool during connection test of the connector.

The disclosure of Japanese Patent Laid-Open No. 2001-257034 1 is intended to compensate for a deformation of an outer wall of the housing, and provides neither any disclosure about a deformation along the bottom surface 202 of the cavity C nor any suggestion about the protruding length of the contact 203.

### SUMMARY

Thus, an object of the invention, among other objects, is to provide a connector in which the length at which contacts held protrude from the connector can be maintained even if the connector is deformed during processing.

The electrical connector includes a plurality of contacts and a female housing. The female housing includes a mating connector receiving cavity, a receiving wall disposed along a bottom of the receiving cavity, a plurality of contact receiving passageways holding the plurality of contacts penetrating there through, and a protrusion protruding from the receiving wall into the receiving cavity.

### BRIEF DESCRIPTION OF THE DRAWINGS

FIG. 1A is a front perspective view of a receptacle connector according to the invention;

FIG. 1B is a rear perspective view of the receptacle connector housing according to the invention;

FIG. 2A is a front view of the receptacle connector according to the invention;

FIG. 2B is a rear view of the receptacle connector according to the invention;

FIG. 3A is a plan view of the receptacle connector according to the invention;

FIG. 3B is a bottom view of the receptacle connector according to the invention;

FIG. 4A is a cross-sectional view of the receptacle connector taken along the line 4a-4a in FIG. 2A;

FIG. 4B is a partially enlarged view of the receptacle connector with a contact removed there from;

FIG. 5 is a cross-sectional view of a connector assembly showing the receptacle connectors assembled with a mating plug connector according to the invention;

FIG. 6A is a sectional view of a known connector having no deformation;

FIG. 6B is sectional view of the known connector showing deformation affecting contact length; and

FIG. 6C is a sectional view of the receptacle connector according to the invention.

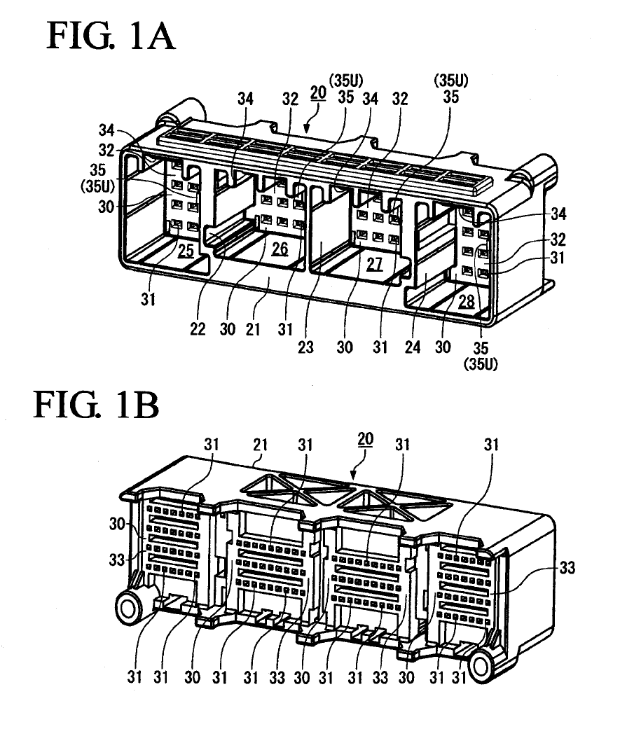

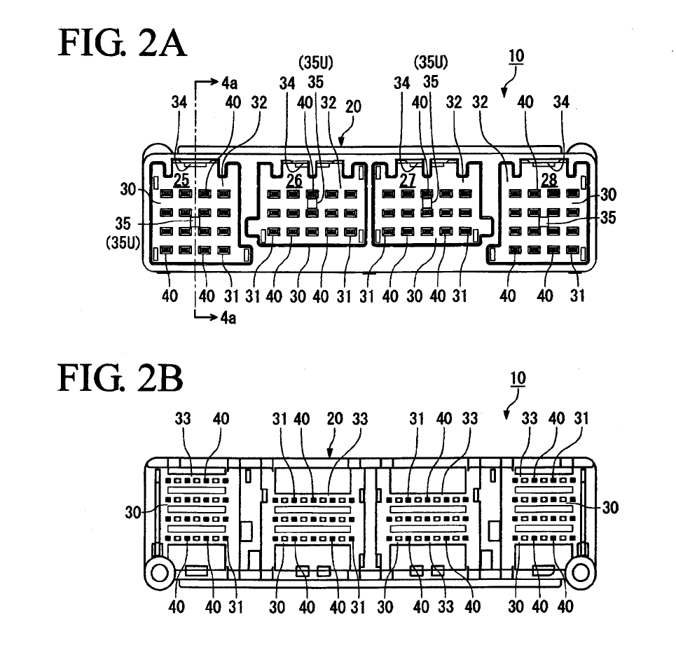

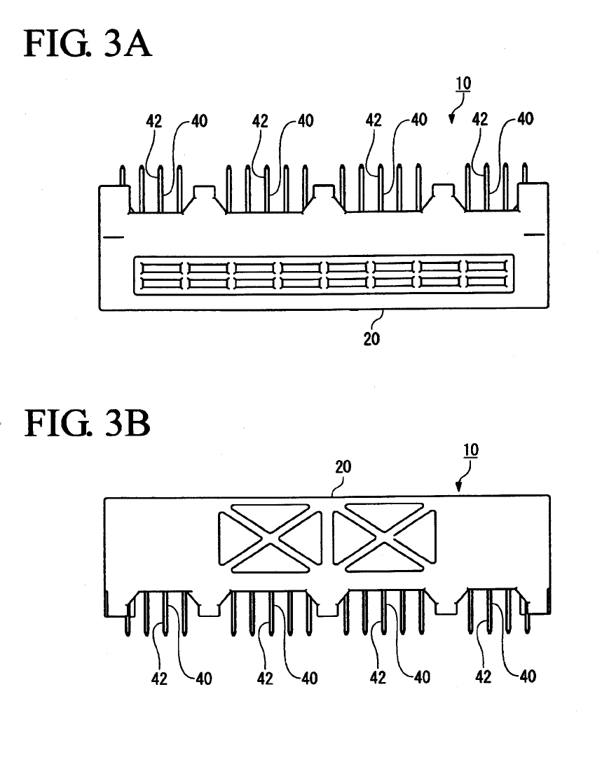

### DETAILED DESCRIPTION OF THE EMBODIMENT(S)

In the following, the invention will be described in detail with regard to an embodiment shown in the accompanying drawings.

A receptacle connector 10 includes an insulating receptacle housing 20 and a plurality of conductive contacts 40.

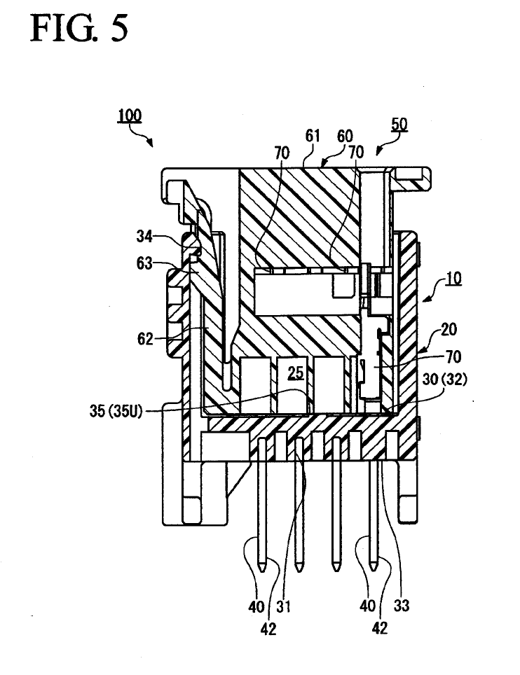

A plug connector 50 (as shown in FIG. 5) includes an insulating plug housing 60 and a plurality of conductive contacts 70. The plug connector 50 is received in the plug receiving cavities 25 to 28 of the housing 20 and thus mated with the housing 20 to form a connector assembly 100.

In the following, major components of the receptacle connector 10 and then of the plug connector 50 will be described in this order.

The female housing 20 having a plurality of contacts 40 is integrally formed by injection molding of a resin.

The housing 20 has a hood 21 opening to the front where the plug connector 50 is mated with the housing 20. The mating part inside the hood 21 is divided by partition walls 22, 23 and 24 into the four plug receiving cavities 25 to 28. Mating parts of the plug connector 50 are inserted into the plug receiving cavities 25 to 28, and the plug connector 50 is thereby mated with the receptacle connector 10. Note that the side of the receptacle connector 10 at which the receptacle connector 10 is mated with the mating plug connector 50 is referred to as a front side, and the opposite side is referred to as a rear side. As for the plug connector 50, the side at which the plug connector 50 is mated with the mating receptacle connector 10 is referred to as a front side, and the opposite side is referred to as a rear side. This definition applies also to the invention.

A receiving wall 30 is disposed along the bottom of each of the plug receiving cavities 25 to 28. The contacts 40 are press-fit into contact receiving passageways 31 formed in the receiving wall 30 and are thereby held in the housing 20. The receiving wall 30 has a thickness that provides a sufficient press-fit margin to hold the press-fit contacts 40. The receiving wall 30 has a bottom surface 32 facing to inside the hood 21 and a back surface 33 opposite to the bottom surface 32. The contact receiving passageways 31 are formed to penetrate from the bottom surface 32 to the back surface 33 at positions corresponding to the contacts 40 to be held. According the embodiment shown, 16 contact receiving passageways 31 are formed in the receiving wall 30 in the receiving cavities 25 and 28, and 15 contact receiving passageways 31 are formed in the receiving wall 30 in the receiving cavities 26 and 27, both in a lattice arrangement.

The hood 21 has a catch 34 inwardly protruding at the front end thereof in each of the receiving cavities 25 to 28. When the receptacle connector 10 and the plug connector 50 are mated with each other, the catch 34 is engaged with a lock 63 formed on a housing 60 of the plug connector 50 to prevent the receptacle connector 10 and the plug connector 50 from separating from each other.

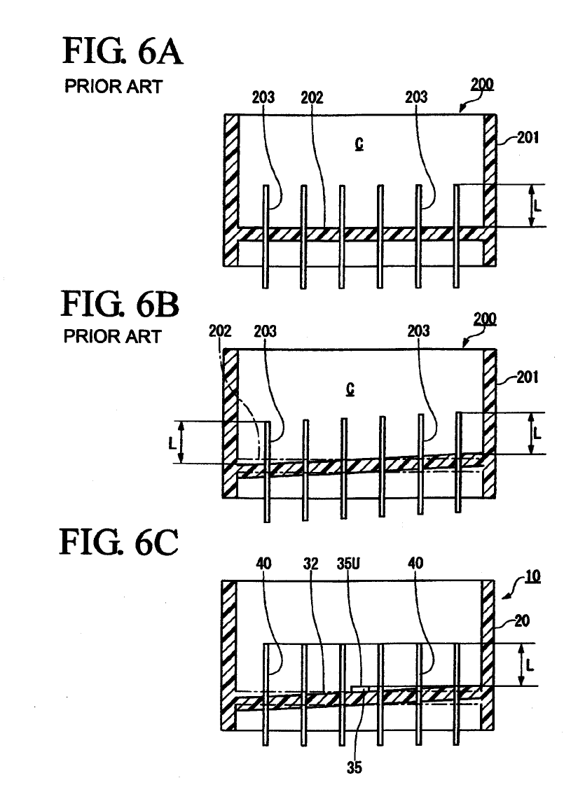

On the bottom surface 32 of the receiving wall 30 in each of the receiving cavities 25 to 28, a protrusion 35 protruding into each of the receiving cavities 25 to 28 is formed integrally with the receiving wall 30 (see FIG. 5). The protrusion 35 is a component characteristic of this embodiment, and a top surface 35U thereof is a planar surface. The protrusion 35 is preferably formed between adjacent contacts 40, so that the area of the top surface 35U can be sufficiently smaller than the area of the bottom surface 32. The top surface 35U constitutes a reference surface used for adjusting a protruding length L of the contacts 40 when the contacts 40 are press-fit into the contact receiving passageways 31. That is, as shown in FIG. 6C, the protruding length L of the contacts 40 according to the invention is defined as the distance from the top surface 35U to the tip ends of the contacts 40. Since the area of the top surface 35U serving as the reference surface is small, no deformation occurs in the reference surface, or any deformation can be easily eliminated.

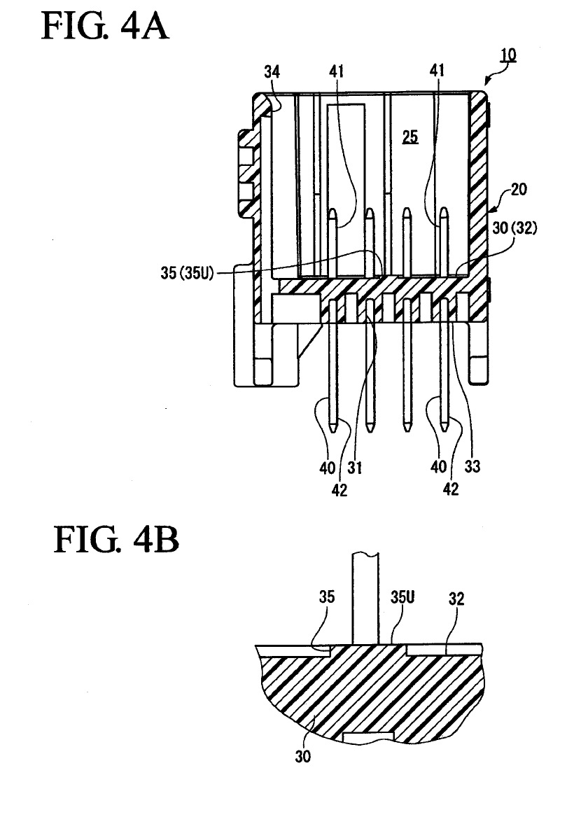

The male contact 40 has a connection section 41 to be connected to a contact 70 of the plug connector 50 at one end and a tine part 42 to be inserted into a connection hole in a substrate (not shown) at the other end (see FIG. 4A). The contact 40 is punched from a thin plate made of a highly conductive and highly elastic material such as a copper alloy.

The plurality of contacts 40 are press-fit into the contact receiving passageways 31 in the receiving wall 30 and thereby held in the housing 20. The contacts 40 are arranged in a plurality of columns in the width direction of the housing 20 and in a plurality of rows in the height direction of the housing 20.

In use, the connection section 41 of each contact 40 is electrically connected to a contact 70 of the plug connector 50, and the tine part 42 is inserted into a connection hole in the substrate (not shown).

Next, major components of the plug connector 50 will be described.

The male housing 60 holding the plurality of contacts 70 is integrally formed by injection molding of a resin.

As shown in FIG. 5, the housing 60 has a main body 61 and a lock lever 62 that extends from the front end of the main body 61 toward the rear end.

The lock lever 62 is a cantilever member. The front end of the lock lever 62, at which the lock lever 62 is connected to the main body 61, is a fixed end, and the lock lever 62 can be bent around the front end.

The lock lever 62 has the lock 63. When the receptacle connector 10 and the plug connector 50 are mated with each other, the lock 63 is engaged with the catch 34 of the housing 20, thereby preventing the plug connector 50 and the receptacle connector 10 from separating from each other.

The female contact 70 has a hollow structure and includes a connection section to be connected to a contact 40 of the receptacle connector 10. The contact 70 is formed by bending a thin metal plate having a predetermined width into a square column shape and, for example, is made of a highly conductive and elastic material, such as a copper alloy.

The plurality of contacts 70 are press-fit into contact receiving passageways (not shown) in the main body 61 of the housing 60 and thereby held in the housing 60. When the receptacle connector 10 and the plug connector 50 are mated with each other, the contacts 40 are inserted into the contacts 70, and the contacts 40 and the contacts 70 are electrically connected to each other. The contacts 70 are also electrically connected to a wire harness (not shown) or the like at the rear end thereof.

The contacts 70 are arranged in a plurality of columns in the width direction of the housing 60 and in a plurality of rows in the height direction of the housing 60 at positions corresponding to the contacts 40.

The connector assembly 100 formed by the receptacle connector 10 and the plug connector 50 according to the invention, when mated with each other is manufactured in the procedure described below.

First, the receptacle connector 10 and the plug connector 50 are placed with the housing 20 facing the housing 60. This placement is performed in such a manner that the receiving cavities 25 to 28 of the housing 20 face the corresponding main bodies 61 of the housing 60.

Then, the housing 60 is pushed until the front ends of the main bodies 61 reach a predetermined position in the receiving cavities 25 to 28. If the front ends of the main bodies 61 come into contact with the protrusions 35 of the housing 20, it means that the housing 60 has been pushed to a predetermined position, and the operation of mating of the receptacle connector 10 and the plug connector 50 is completed. In the course of the process of pushing the housing 60 to the predetermined position, the lock 63 climbs over the catch 34 of the housing 20 and then restores the original state. Once the lock 63 restores the original state, the lock 63 and the catch 34 are engaged with each other, so that the plug connector 50 and the receptacle connector 10 are prevented from separating from each other even if the plug connector 50 is pulled.

In the following, effects and advantages of this embodiment will be described.

According to the embodiment shown, the top surface 35U of the protrusion 35 has a small area. Therefore, the housing 20 without deformation in the reference surface can be easily fabricated by injection molding as described below.

If the housing 20 is fabricated by injection molding, deformation may occur in the bottom surface 32. The deformation appears as an inclined surface as shown in FIG. 6C, for example. In FIG. 6C, the design bottom surface 32 is indicated by the alternate long and short dash line. Although the deformation can be reduced by adjusting the injection molding die, it is difficult in many cases to eliminate the deformation over the wide area of the bottom surface 32. However, the protrusion 35 has a smaller area than the bottom surface 32, so that no deformation occurs, or any deformation can be substantially more easily eliminated by adjusting the molding surface of the die than the deformation of the bottom surface 32.

Since no deformation occurs in the reference surface, each contact 40 can have a required protruding margin to ensure an adequate length of connection to the contact 70. This means that the protruding margins of the contacts 40 on the side of the back surface 33 can be precisely aligned with each other. The larger the dimensions of the housing 20 are, the more remarkable this advantage becomes.

In particular, in this embodiment, one protrusion 35 is formed in each receiving cavity 25 (26, 27, 28). As a result, the top surface 35U is the only reference surface in the receiving cavity 25 (26, 27, 28), so that the plurality of contacts 40 can be precisely aligned with each other in the front-rear direction at appropriate positions to ensure the required length of connection.

In some cases, the protruding margins of the contacts 40 are measured after press-fitting of the contacts 40. In such cases, the measurement is conventionally made with respect to a point on each contact 40 close to the root of the contact 40. According to this embodiment, however, the protruding margins of the contacts 40 in the receiving cavity 25 (26, 27, 28) are measured with respect to a common reference point, that is, the top surface 35U of the protrusion 35, and therefore, the measurement of the protruding margin can be easily made.

Furthermore, according to the embodiment shown, since the reference surface (i.e. top surface 35U) without deformation of each of the plurality of receiving cavities 25, 26, 27 and 28 can be easily formed, the positions of the reference surfaces of the receiving cavities 25, 26, 27 and 28 in the front-rear direction can also be easily aligned with each other. As a result, even when an automated mechanical devices is used to insert the contacts 40 into the receiving walls 30 of the plurality of receiving cavities 25, 26, 27 and 28, the contacts 40 can be precisely aligned with each other in the front-rear direction at appropriate positions to ensure the required length of connection.

As described above, since the contacts 40 can be precisely aligned with each other in the front-rear direction at appropriate positions to ensure the required length of connection, the connector assembly 100 formed by the receptacle connector 10 and the plug connector 50 mated with each other can ensure an adequate length of electrical connection between the contacts 40 and the contacts 70. If the contacts 40 are precisely aligned with each other as described above, a “relative twist” less readily occurs between the contacts 40 and the contacts 70 even if the length of the hood 21 is reduced. This contributes to downsizing of the housing 20 and therefore the receptacle connector 10.

The contacts 40 can also be precisely aligned with each other in the front-rear direction on the rear side of the receptacle connector 10. Therefore, an adequate length of electrical connection to the substrate (not shown) can be ensured. Thus, the connector assembly 100 according to this embodiment has high connection reliability.

Furthermore, in this embodiment, if the position of the catch 34 is determined with respect to the top surface 35U, the catch 34 can be formed with reliability at a position where appropriate mating with the plug connector 50 can be performed.

Although the protrusion 35 has the shape of a square column in the embodiment described above, the protrusion according to the invention is not limited thereto. For example, the protrusion 35 can also have the shape of other polygonal columns, a circular column, a truncated conical column or the like. In addition, the top surface of the protrusion 35 may not be a planar surface. For example, the top surface can be an arc surface, for example, as far as it can serve as the reference surface.

The height of the protrusion 35 is not particularly limited, as far as the top surface of the protrusion 35 serves as the “reference surface”. However, in the case where the top surface is a planar surface, the height of the protrusion 35 is preferably equal to or larger than the flatness in order to achieve the required flatness. In the invention, the flatness of an area between two parallel planes spaced apart from each other by a distance t is defined as t.

According to the invention, the position of the protrusion 35 is appropriately determined depending on the shape of the housing 20. In many of the cases where one protrusion 35 is formed in each of the receiving cavities 25 to 28, the protrusion 35 is preferably formed substantially at the center of the receiving wall in the planar direction. A plurality of protrusions 35 may be formed in each of the receiving cavities 25 to 28. In particular, a plurality of protrusions 35 can be formed when the open area of the receiving cavities 25 to 28 is large.

The components described in the above embodiment can be appropriately omitted or modified without departing from the spirit of the invention. For example, the invention can also be applied to a connector having a single receiving cavity.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An electrical connector, comprising:
a plurality of contacts; and
a female housing having a mating connector receiving cavity, a receiving wall disposed along a bottom of the receiving cavity, a plurality of contact receiving passageways holding the plurality of contacts penetrating there through, and a protrusion protruding from the receiving wall into the receiving cavity.

2. The electrical connector according to claim 1, wherein a top surface of the protrusion is a planar surface.

3. The electrical connector according to claim 2, wherein a protrusion height of the protrusion from the bottom is equal to or greater than a flatness of the top surface.

4. The electrical connector according to claim 1, wherein the protrusion is disposed between adjacent contacts.

5. The electrical connector according to claim 1, wherein the protrusion is disposed in a center of the receiving wall.
